(19) United States
(12) Patent Application Publication
(10) Pub. No.: US 2025/0387742 A1
(43) Pub. Date: Dec. 25, 2025

(54) Filter Extraction System

(71) Applicant: Tiny Holdings Co, LLC, Arvada, CO (US)

(72) Inventors: Levi Garrett Lanzrath, Lakewood, CO (US); Matthew McNeil, Denver, CO (US); Steven Knabe, Arvada, CO (US)

(21) Appl. No.: 19/317,095

(22) Filed: Sep. 2, 2025

Related U.S. Application Data
(63) Continuation-in-part of application No. 19/241,037, filed on Jun. 17, 2025.
Application No. 19/241,037 is a continuation-in-part of application No. 18/412,234, filed on Jan. 12, 2024.
(60) Provisional application No. 63/479,899, filed on Jan. 13, 2023.
(60) Provisional application No. 63/660,897, filed on Jun. 17, 2024.

(51) Int. Cl. B01D 46/00; B01D 46/24

(52) U.S. Cl. CPC B01D 46/0005; B01D 46/2411; B01D 2201/0415; B01D 2201/30

(57) ABSTRACT

A filter extraction system for filtering a botanical resin mixture in a container. An agitator assembly is configured to be spun in the container by a driver head and agitate the mixture. The mixture can be poured from the container and filtered such that botanical resin is removed from the mixture.

### CROSS-REFERENCE TO RELATED APPLICATIONS

This application is a continuation-in-part of U.S. Non-provisional patent application Ser. No. 19/241,037 filed Jun. 17, 2025, which is a continuation-in-part of U.S. Non-provisional patent application Ser. No. 18/412,234 filed Jan. 12, 2024, which claims the benefit of U.S. Provisional Patent Application No. 63/479,899 filed Jan. 13, 2023, the entire contents thereof are herein incorporated by reference. This application also claims the benefit of U.S. Provisional Patent Application No. 63/660,897 filed Jun. 17, 2024, the entire contents thereof are herein incorporated by reference.

### BACKGROUND OF THE INVENTION

### 1. Field

The disclosed embodiments relate generally to apparatuses used to extract botanical resins from plant-based source materials.

### 2. Description of the Related Art

It is known to have an apparatus for extracting botanical resins from plant-based materials.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages will be apparent from the following detailed description of the embodiments and the accompanying drawing figures.

In some embodiments, the techniques described herein relate to a system including: a container; a driver head; a shaft configured to be suspended down into the container and operatively connected to the driver head to rotate the shaft; a first downwardly directed impeller located at an intermediate portion of the shaft to create downwardly directed turbulence; and a second upwardly directed impeller located at a lower position on the shaft to create an upwardly directed turbulence opposite the downwardly directed turbulence generated by the first downwardly directed impeller.

In some embodiments, the techniques described herein relate to a system wherein the shaft includes a driver-attaching end configured to be pushed into and held within a hub fitting of the driver head such that the driver-attaching end may be removed from and secured into the driver head.

In some embodiments, the techniques described herein relate to a system wherein the driver head includes an outwardly extending ledge configured to sit on an upper edge of the container directly above screw threads disposed around a mouth of the container, the screw threads being configured for receiving a container ring.

In some embodiments, the techniques described herein relate to a system wherein the container ring includes an inwardly extending shelf, and the outwardly extending ledge of the driver head is clamped above the upper edge of the container and underneath the inwardly extending shelf when the container ring is screwed onto the screw threads.

In some embodiments, the techniques described herein relate to a system wherein the driver head includes: a controller configured to receive inputs and control an operating speed and a session time of the driver head; and an indicator arrangement including a plurality of light emitting diodes (LEDs) radially spaced apart on an upper portion of the driver head, the plurality of LEDs being responsive to an operational status.

In some embodiments, the techniques described herein relate to a system wherein the controller is communicatively coupled to the indicator arrangement such that the controller controls an illumination intensity and color of the LEDs to correspond to the operating speed and the session time of the shaft.

In some embodiments, the techniques described herein relate to a system wherein the first downwardly directed impeller includes flow-compelling ridges extending downwards from a lower facing surface of the first downwardly directed impeller, and the flow-compelling ridges compel flow downwards towards the second upwardly directed impeller.

In some embodiments, the techniques described herein relate to a system wherein the second upwardly directed impeller includes flow-compelling ridges extending upwards from an upper facing surface of the second upwardly directed impeller, and the flow-compelling ridges compel flow upwards towards the first downwardly directed impeller.

In some embodiments, the techniques described herein relate to a system including: a container including a wide-mouth and screw threads disposed around the circumference of the wide-mouth wherein the screw threads are configured for receiving a container ring; a driver head configured to be clamped between the container and the container ring directly above the wide-mouth of the container, wherein the driver head is configured to operatively connect to a shaft suspended in between walls of the container; wherein the shaft includes an impeller configured to generate flow dynamics.

In some embodiments, the techniques described herein relate to a system wherein the driver head includes an outwardly extending ledge which extends around the circumference of the driver head such that the circumference of the outwardly extending ledge matches the circumference of an upper edge of the wide-mouth of the container and the outwardly extending ledge sits directly on the upper edge.

In some embodiments, the techniques described herein relate to a system wherein the container ring includes an inwardly extending shelf, and the outwardly extending ledge of the driver head is clamped between the upper edge of the container and the inwardly extending shelf when the container ring is screwed onto the screw threads.

In some embodiments, the techniques described herein relate to a system including a pour spout attachment as an alternative attachment to the driver head, the pour spout attachment having an outwardly extending ledge having a diameter which is substantially identical to that of the outwardly extending ledge of the driver head such that the pour spout attachment may be clamped between the upper edge of the container and the inwardly extending shelf when the container ring is screwed onto the screw threads.

In some embodiments, the techniques described herein relate to a system including a filter accessory kit, the kit including: a filter holder including a substantially cylindrical wall, a floor, and a drain pipe extending down from the floor; a filter stand wherein the filter stand includes a platform area having an aperture defined therethrough, the aperture being sized to receive the drain pipe therethrough when the filter holder is placed atop the platform area, the platform area supported atop a plurality of legs, each leg in the plurality initially radiating out from the platform area, then extending downwardly to support the platform above a surface; the drain pipe configured to receive a collection bag.

In some embodiments, the techniques described herein relate to a system including a first cylindrical filter and a second cylindrical filter wherein the second cylindrical filter has a smaller diameter than the first cylindrical filter and fits within the first cylindrical filter and the first cylindrical filter is configured to be received inside the substantially cylindrical wall of the filter holder.

In some embodiments, the techniques described herein relate to a system wherein the first cylindrical filter includes a first mesh lining which stretches across the bottom of the first cylindrical filter, and the second cylindrical filter includes a second mesh lining which stretches across the bottom of the second cylindrical filter.

In some embodiments, the techniques described herein relate to a system wherein the first mesh lining has a mesh structure more tightly woven than a mesh structure of the second mesh lining, such that the first cylindrical filter collects matter which passes through the second cylindrical filter.

In some embodiments, the techniques described herein relate to a system wherein the legs of the filter stand are configured to be at a distance apart such that they can accomplish a secured fit around the container when the driver head and the pour spout attachment are removed from the container.

In some embodiments, the techniques described herein relate to a system wherein a set of external threads on the drain pipe are configured to mate with a set of corresponding internal threads existing in the aperture in the platform, enabling the drain pipe to be screwed through and partially extend below the platform exposing a drain tip that can then receive a collection bag.

In some embodiments, the techniques described herein relate to a system further including: a pour spout attachment configured to be attached to the container alternatively to the drive head; and the filter holder is configured to be attachable to the filter stand such that when a solution is poured out of the container and through the first and the second cylindrical filters supported within the filter holder, the drain pipe, and then the collection bag, diverse forms of plant matter are established in each of the first and the second cylindrical filters and the collection bag.

In some embodiments, the techniques described herein relate to a system including: a container including a wide-mouth and screw threads disposed around the circumference of the wide-mouth wherein the screw threads are configured for receiving a container ring; a driver head configured to be clamped between the container and the container ring directly above the wide-mouth of the container; a shaft configured to be suspended down into the container and operatively connected to the driver head to rotate the shaft; a first downwardly directed impeller located at an intermediate portion of the shaft to create downwardly directed turbulence; a second upwardly directed impeller located at a lower position on the shaft to create an upwardly directed turbulence opposite the downwardly directed turbulence generated by the downwardly directed impeller; a filter holder including an outer shell and a hollow shaft extending from a bottom surface of the outer shell, wherein the hollow shaft includes external threads around its circumference; and a filter stand wherein the filter stand includes legs positioned spacedly apart and which converge together towards a threaded hole, wherein the threaded hole is configured to receive the external threads of the hollow shaft to attach the filter holder to the filter stand.

### BRIEF DESCRIPTION OF THE SEVERAL VIEWS OF THE DRAWINGS

Illustrative embodiments are described in detail below with reference to the attached drawing figures, which are incorporated by reference herein and wherein:

FIG. 1 is a view of components of the filter extraction system in embodiments;

FIG. 2A is a perspective view of an agitator assembly of the filter extraction system of FIG. 1;

FIG. 2B is another perspective view of the agitator assembly of the filter extraction system of FIG. 1;

FIG. 3 is a perspective view of a container of the filter extraction system of FIG. 1;

FIG. 4 is a cross-sectional view of a driver head attached to the agitator assembly of FIG. 2A;

FIG. 5 is a cross-sectional view of the driver head of FIG. 4;

FIG. 6A is a perspective view of the driver head of FIG. 4 being placed on top of the container of FIG. 3;

FIG. 6B is a perspective view of a container ring being used to secure the driver head FIG. 4 to the container of FIG. 3;

FIG. 7A is a perspective view of a pour spout attachment of the filter extraction system of FIG. 1;

FIG. 7B is a perspective view of the pour spout attachment of FIG. 7A secured onto the container using the container ring of FIG. 6B;

FIG. 8 is a perspective view of a filter stand of the filter extraction system of FIG. 1;

FIG. 9 is a perspective view of two cylindrical filters and a filter holder of the filter extraction system;

FIG. 10 is a perspective view of the filter holder of FIG. 9 with a collection bag of the filter extraction system of FIG. 1;

FIG. 11 is a perspective view of the collection bag of FIG. 10 and the filter holder of FIG. 9 attached to the filter stand of FIG. 8;

FIG. 12 is a perspective view of the filter extraction system disassembled and arranged for storage;

FIG. 13 is a method for executing an extraction using the disclosed system;

FIG. 14 is a perspective view of the driver head of FIG. 4 attached to the container of FIG. 3.

The drawing figures do not limit the invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the invention. The following detailed description is, therefore, not to be taken in a limiting sense. The scope of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc., described in one embodiment may also be included in other embodiments but is not necessarily included. Thus, the technology can include a variety of combinations and/or integrations of the embodiments described herein.

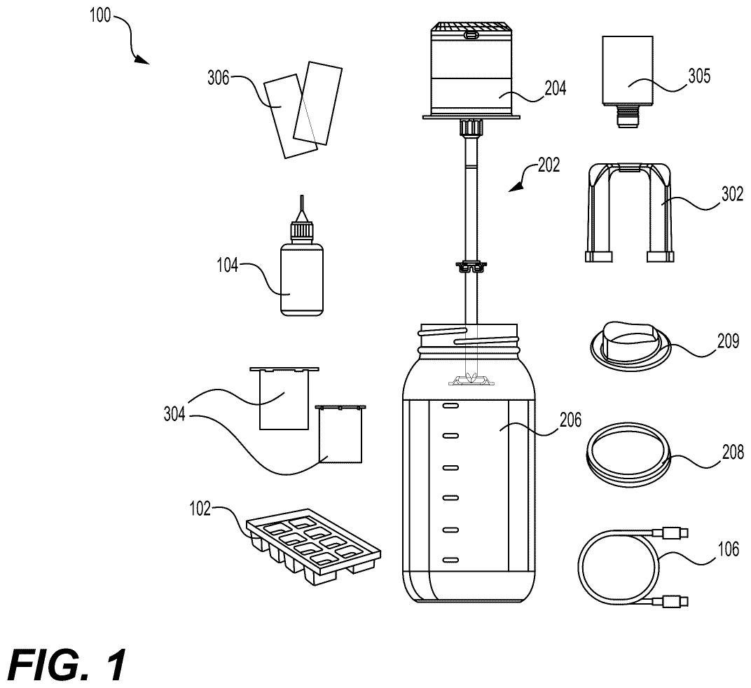

Embodiments disclosed herein provide a system and a method for extracting botanical resin from plant source materials. In embodiments, and with reference to FIG. 1, the filter extraction system 100 includes a driver head assembly and a filter stand assembly. In embodiments, the driver head assembly comprises an agitator arrangement 202, a rotation implementing driver head 204 used to actuate the agitator arrangement 202, a container 206, a container ring 208, and a pour spout attachment 209.

In embodiments, a filter accessory kit can be attached and disconnected from the container as will be discussed hereinafter. The filter accessory kit includes a filter stand 302, cylindrical filters 304A and 304B, a filter holder 305, and a collection bag 306. In embodiments, the filter extraction system 100 also includes an ice tray 102, a collection spray bottle 104, and a charging cable 106 along with a power supply (not shown)

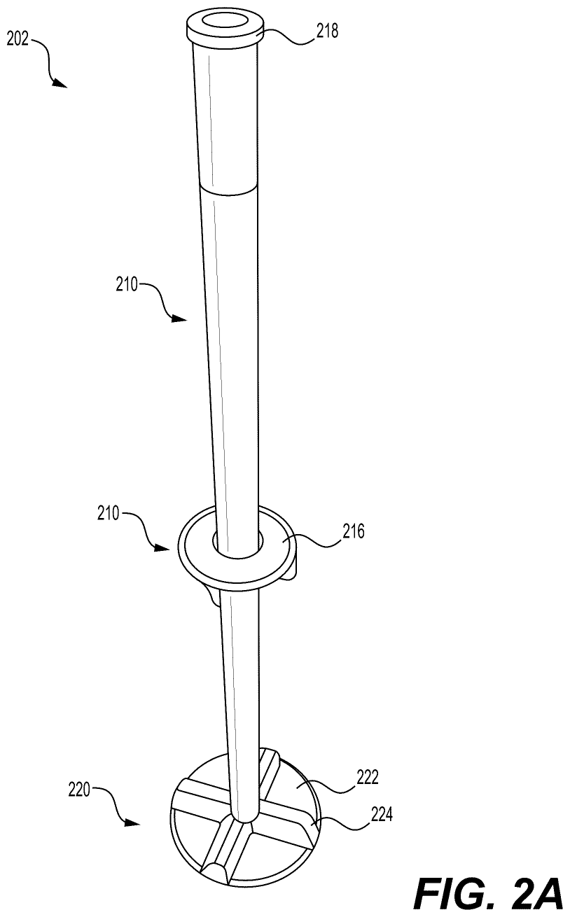

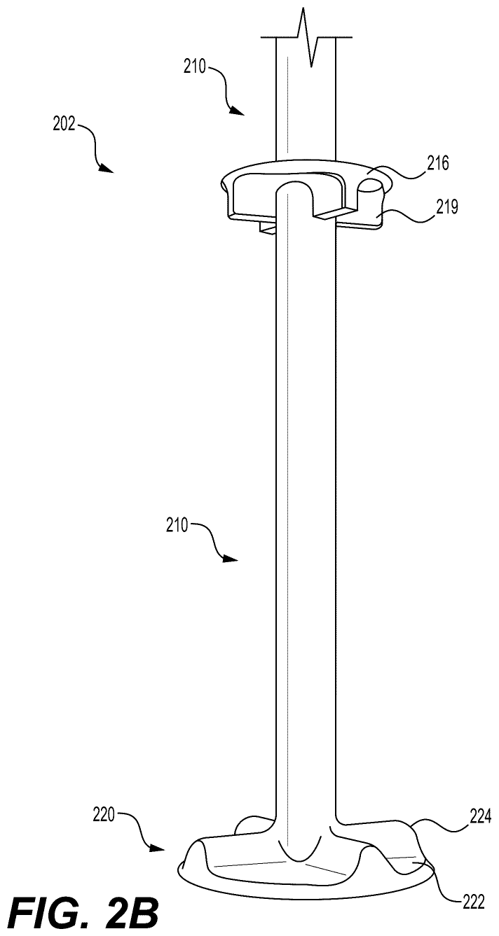

FIGS. 2A and 2B show the agitator arrangement 202 of the driver head assembly comprising a downwardly-directed upper impeller 216 and an upwardly-directed lower impeller 220. The upper and lower impellers 216 and 220 are integrally formed on a drivable shaft 210 which is connectable into and extends downward from the driver head 204.

Downwardly-directed upper impeller 216 is, in embodiments, shaped as a circular disk being relatively smooth on its upper facing surface with flow-compelling vanes/ridges 219 (FIG. 2B) extending downwards from its lower facing surface. The configuration compels the flow of any contained ice-bath botanical solution downward towards the lower impeller 220.

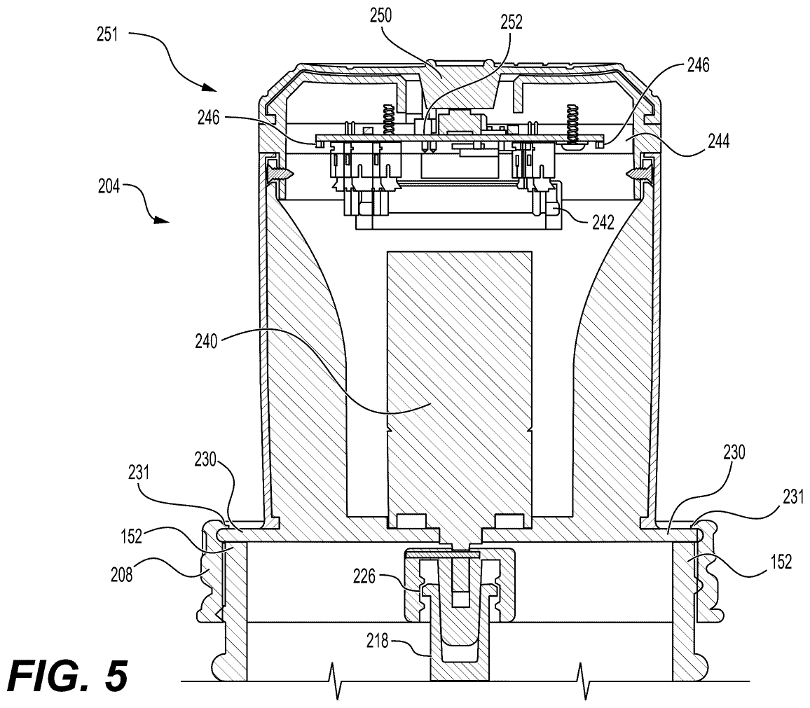

A top end of the shaft 210 includes a driver-attaching end 218. The driver-attaching end 218 may include grooves, ledges, or teeth configured to engage with the center axle of driver head 204 and become secure (FIG. 5). In embodiments, the driver-attaching end 218 may be a lever lock twist fitting into the driver 204.

The lower impeller 220 at the opposite lower end of the shaft 210 includes a circular disk 222 with upwardly-outcropped vanes/ridges 224 which will, upon rotation of shaft 210, direct flow of fluids upwards towards the opposing vanes/ridges on the underside of disk 216.

When attached, the driver head 204 can be configured to rotate the agitator assembly 202 in a clockwise direction (top view reference). In alternative embodiments the system could be configured to in a counterclockwise direction or both directions depending on the embodiment. Regardless, upon actuation driver head 204, the upper and lower impellers 216 and 220 rotate together and the opposed vanes/ridge arrangements 219 and 224 impart opposing downward and upward flows and turbulence which effectively break up and mix/stir the botanical solution. More specifically, the downwardly-directed vanes 219 on upper impeller 216 create downwardly swirling vortices which encounter interfering upwardly swirling vortices generated by the upwardly directed vanes 224 on the lower impeller 220.

The entire agitator assembly 202 is sized with an overall length to fit within the container 206 with, in embodiments, a one-millimeter to three-millimeter gap between the circular disk 222 of the agitator assembly 202 and the bottom of the container 206. In embodiments, the container 206 may have a volume of approximately sixty-four ounces or 2000 mL.

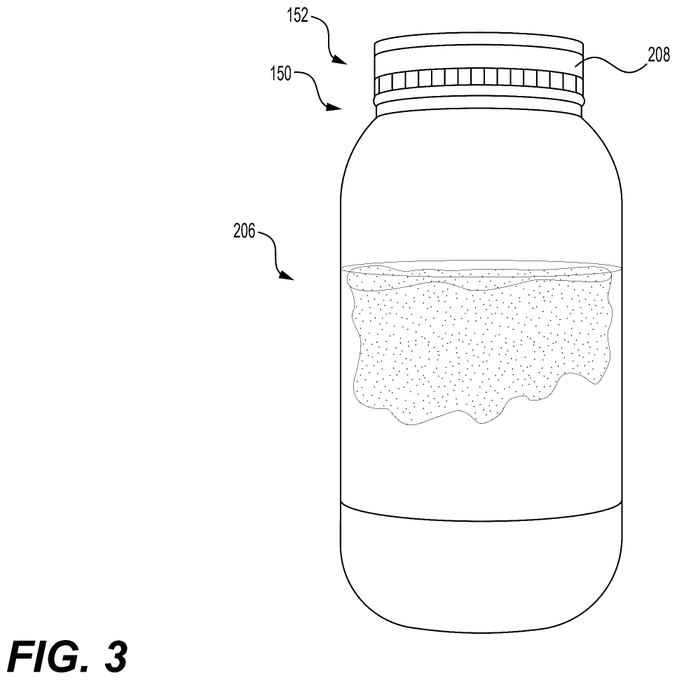

The container 206 (see FIG. 3) is, in embodiments, constructed of glass and is otherwise suitable for holding a liquid ice-bath botanical solution. In other embodiments, container 206 may be formed from plastic, metal, or ceramic. In some embodiments, the container 206 may comprise a commercially available glass jar such as is used in canning and storing of food items. The container 206 may range in size from about fifty ounces to about one-hundred ounces. Advantageously, the container 206 selected has a “wide-mouth” with an upper edge 152 including screw threads 150 for receiving a container ring 208 which in different modes of operation will be used to secure either the driver head 204 or a pour spout attachment 209 as will be discussed hereinafter. In embodiments, the container 206 may be what is known as a mason jar.

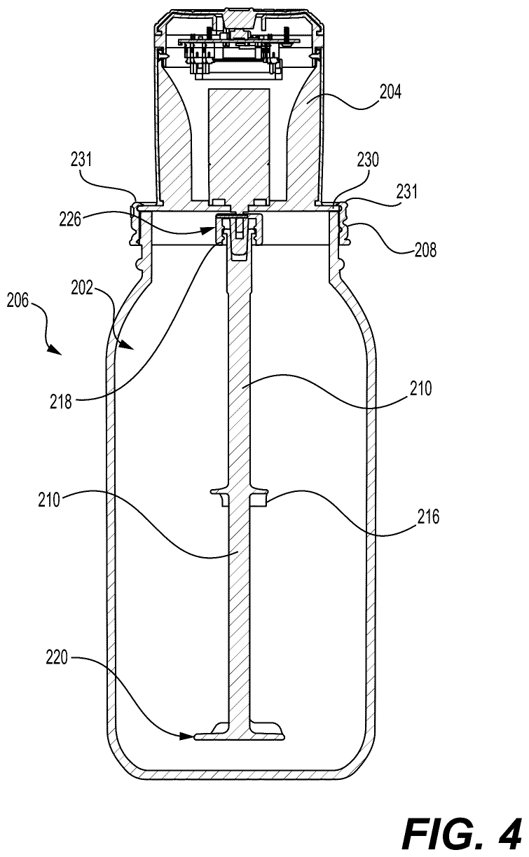

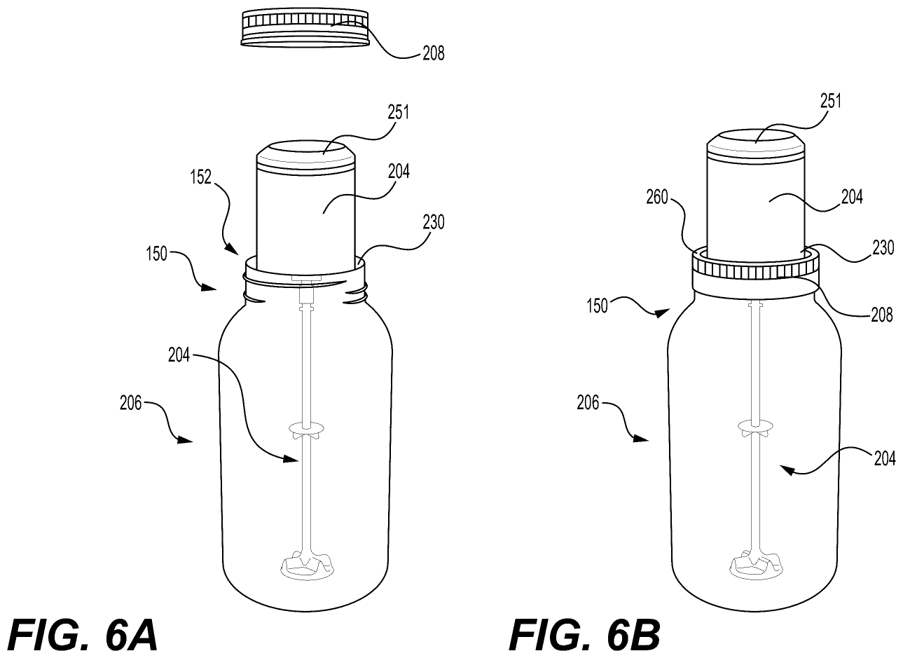

FIG. 4 shows a cross-sectional view of the driver head 204 attached to the agitating assembly 202. More specifically, the driver-attaching end 218 of the shaft 210 is configured to be pushed into and held within (by a friction fit) into a hub fitting 226 configured in the bottom of driver head 204. In embodiments, the driver head 204 is attached to the container 206 when inwardly extending shelves 231 on the container ring 208 clamp down onto an outwardly extending ledge 230 forming the lower edge of the base of the driver head 204 (see FIG. 6B) when ring 208 is screwed onto threads 150 of the container 206.

FIG. 5 shows a cross-sectional view of the driver head 204. In embodiments, the driver head 204 is equipped with a DC motor 240 and one or more Li—Po batteries 242 accessible with a USBC charging power port 244. The one or more Li—Po batteries 242 may be charged using the charging cable 106 along with a power supply (not shown) and is configured to provide power to the DC motor 240 which drives spinning of the agitation device 202 depending on mode of operation. The driver head 204 is configured to spin the agitator assembly 202 such that the rotation of the agitator assembly 202 and upper impeller 216 and lower impeller 220 will break off unwanted plant matter. In embodiments, the driver head 204 may be configured to spin at relatively high rotations-per-minute (RPM) and low RPMs. When rotation is imparted into shaft 210 by the driver head 204, the resulting rotation of the upper facing vanes/ridges 224 along with the downwardly facing vanes/ridges 219 generates desirable flow dynamics within the container 206. The resulting turbulence separates trichomes from the botanicals/substantially in container 206.

The driver head 204 is battery powered by the one or more Li—Po batteries 242 which may be charged using the USB charging cable 106 in a known manner. With reference to FIGS. 5 and 15, the driver head 204 also optionally includes a plurality of radially spaced apart light emitting diodes (LEDs) 246 which may be configured to give indication of the speed setting (RPM) the DC motor 240 is spinning the agitator assembly 202 at. In embodiments, the brightness or the number of LEDs 246 lit up may correspond to the RPM the agitator assembly 202 is operating at. Additionally, the LEDs 246 may change color to indicate the amount of time the agitator assembly 202 is set to spin. For instance, a blue light display from the LEDs 246 may indicate a session time of about ten minutes, a green light display may indicate a session time of about twenty minutes, and a red light display may indicate a session time of about thirty minutes. In some embodiments, the LEDs 246 may be configured to “count down” to an end of a session time. For instance, at the start of a ten-minute session, a plurality of LEDs may be illuminated and after each passing minute, an LED may be dimmed until the session time is completed. In embodiments, the driver head 204 comprises a mode select push button/power button 250 configured on the lid 251 of the driver head 204 which interact with a programmable printed circuit board (PCB) 252. The PCB 252 additionally includes one or more processing components configured to operate both driver head 204 drive functions as well as be communicatively coupled to and operate the LED indicator arrangement 246. The mode select/power button 250 allows a user to select a mode of operation which may include selecting an operating speed and session time for the agitator assembly 202 to spin. In embodiments, the operating speed may be adjusted by single pressing the power button 250 and the session time may be adjusted by double-pressing the power button 250. In embodiments, the processing component of the PCB 252 is configured such that the power button 250 may be held approximately four seconds to turn the driver head 204 ON or OFF. The power button 250 may be held approximately nine seconds to reset the driver head 204. In other embodiments, the driver head 204 may comprise alternative LED arrangements, power and mode selection configurations, and alternative power supply and charging arrangements, any of which should not be considered limiting within the scope of this application. Moreover, you can use the button to look up the firmware installed which is displayed by the LEDs. The LEDs also provide error codes—for example if there is a stall/overcurrent issue a particular code is flashed with the LEDs

FIG. 6A and FIG. 6B show the container ring 208 being used to secure the driver head 204 onto, and already attached agitator assembly 202 into, the container 206. The driver head 204 is able to sit on the upper edge 152 of the wide-mouth of the container 206 directly above the screw threads 150 due to the outwardly extending ledge 230 extending around the circumference of the driver head 204 from its base. The circumference of the outwardly extending ledge 230 substantially matches the circumference of the upper edge 152 of the container 206. Once the container ring 208 is brought over the top of the driver head 204 the inward shelf 231 rests atop the outer ledge 230 of the head 204. Because the inwardly extending shelf 231 has an inside diameter that is slightly smaller than the diameter of the outer ledge 230, a screwing down of ring 208 onto the threads 150 on the container causes a clamping down that secures the driver head 204 in place. The details of the fully secured ledge 230 being secured underneath the inwardly extending shelf 231 can best be seen in FIG. 5. This attachment secures the head on the upper edge 152 that defines the mouth of the container 206.

When the driver head 204 is secured to the container 206, the agitator assembly 202 is suspended downward such that the lower impeller 220 is immediately above the floor of the container 206 creating a gap that is approximately one to three millimeters.

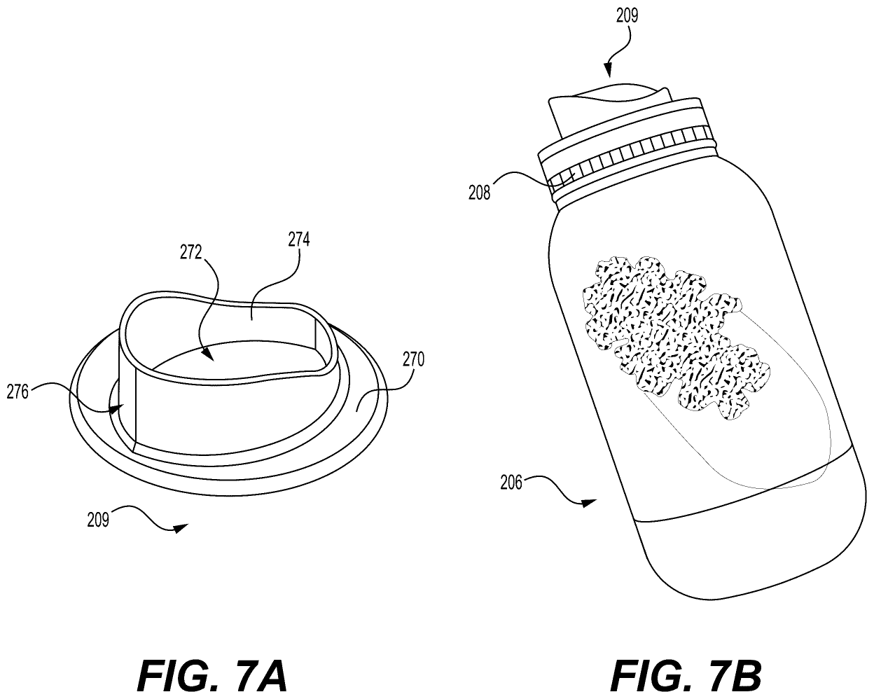

FIG. 7A shows a perspective view of the pour spout attachment 209 and FIG. 7B shows a perspective view of the pour spout attachment 209 attached to the container 206. The pour spout attachment 209 comprises a base with an outwardly extending ledge 270 and an opening 272 created in between spout walls 274. The opening 272 is centered about the base and the spout walls 274 extend perpendicular to the outwardly extending ledge 270 and form the sides of the circular opening 272. Some portions of the spout walls 274 are more protruded than others at an oblong portion 276. When using the pour spout attachment 209, a fluid or solution is able to be directed through the oblong portion 276 due to its creased geometry relative to the circular opening 272 and spout walls 274. With reference to FIG. 7B, the pour spout attachment 209 is configured to be placed onto the upper edge 152 of the container 206 and secured to the container 206 using the container ring 208 in a similar fashion to how the driver head 204 is secured to the container 206. More specifically, the outwardly extending ledge 270 can be clamped down underneath the inwardly extending shelf 231 of the container ring 208 is the same way as described above for ledge 230 seen in FIG. 5 (driver head installation). When secured to the container 206, botanical resin solution and water in the container 206 is able to be poured out of the container 206 through the oblong portion 276 of the pour spout attachment 209.

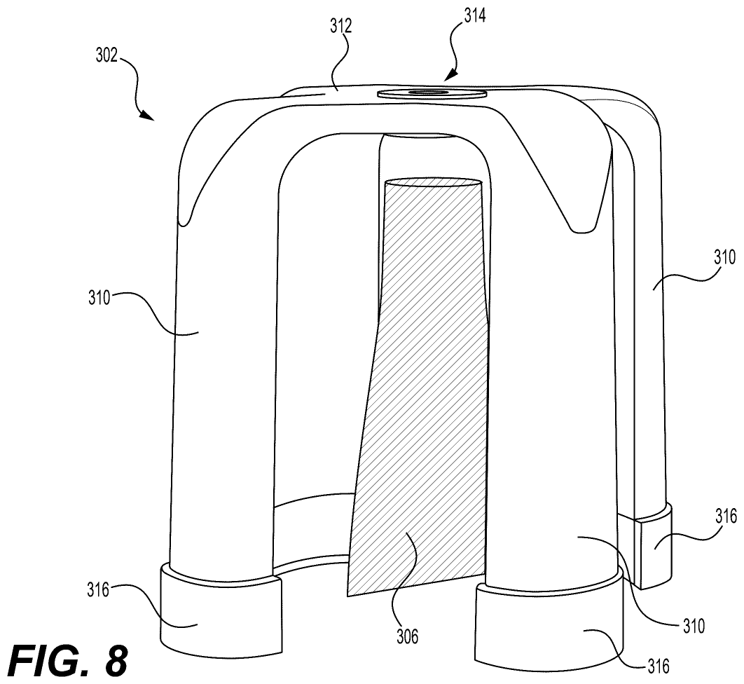

FIG. 8 shows the filter stand 302 of the filter stand assembly with a collection bag 306. In embodiments, the filter stand 302 comprises four legs 310 which each initially radiate outwards from the platform area 312, then extend downwardly to support the platform above a surface. The platform area 312 includes aperture 314 which extends through the platform area 312 and is centered in between the legs 310. The legs 310 are shaped and spaced apart to create space beneath the aperture 314 for a collection bag 306. Collection bag 306 is placed beneath the aperture 314 to receive filtered botanicals. In some embodiments, each leg 310 end may include a grip enhancing cover 316 to substantially provide grip for the filter stand 302 when it is placed in a sink or other area where it may be prone to sliding.

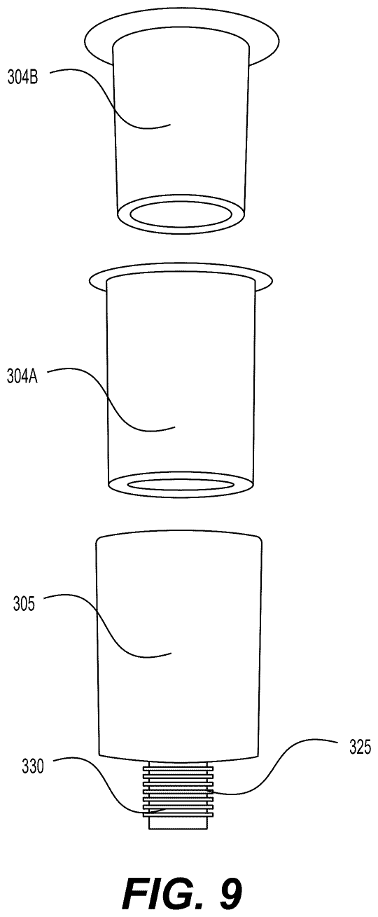

FIG. 9 shows a perspective view of the cylindrical filters 304A and 304B and the filter holder 305. In embodiments, the cylindrical filters 304A and 304B comprise an outer shell which forms an opening covered with a mesh or lining. The mesh/lining may be stretched across the opening near the base of either cylinder and substantially acts as a filter which filters out and collects larger particles of resin matter too large to pass through the mesh while allowing smaller particles to pass through. In embodiments, the cylindrical filter 304A is a 160-micron (u) filter cylinder and the cylindrical filter 304B is a 220u filter cylinder. The mesh structure of the 160u cylindrical filter 304A is more tightly woven than the mesh structure of the 220u cylindrical filter 304B such that the cylindrical filter 304A will collect smaller particles of the botanical resin matter than the cylindrical filter 304B.

In embodiments, the 220u micro cylindrical filter 304B has a smaller diameter than the 160u cylindrical filter 304A which allows the cylindrical filter 304B to be placed into the cylindrical filter 304A. The cylindrical filter 304A has a smaller diameter than the filter holder 305 which allows the cylindrical filter 304A to be placed into the filter holder 305. The filter holder 305 includes a substantially cylindrical wall and a cylindrical drain pipe 330 extending downwards from the floor of the filter holder 305. The drain pipe 330 is hollow with a smaller diameter than the filter holder 305 and opens to the inside of the filter holder 305 such that solution or matter within the filter holder 305 will drain out of the drain pipe 330. The drain pipe 330 is configured to secure the filter holder 305 to the filter stand 302 with a set of external threads 325 inserting and being mated with a set of threads within the aperture 314 of the filter stand 302.

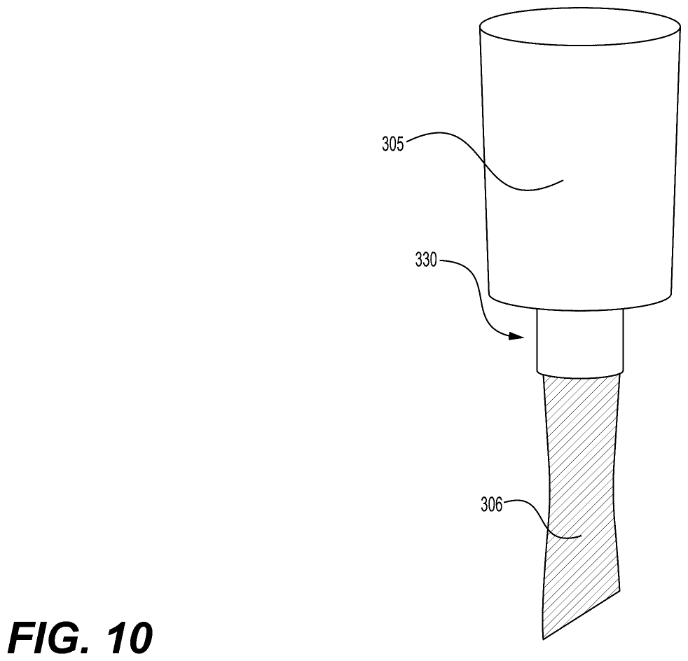

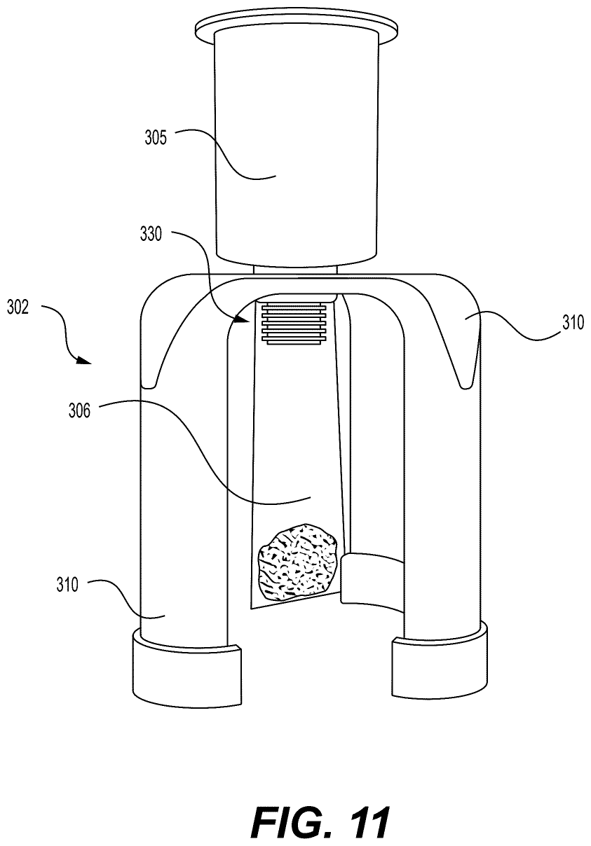

With reference to FIG. 10 and FIG. 11, the collection bag 306 is placed over the drain pipe 330 of the filter stand 302 such that when the drain pipe 330 is threaded into the aperture 314 and a tip of the drain pipe 330 extends below platform area 312 of the filter stand 302, the collection bag 306 is secured over the drain pipe 330 such that resin solution poured through the drain pipe 330 is directed to the collection bag 306. In some embodiments, the collection bag 306 includes a cord to alter the shape of the bag opening and tie the bag to the drain pipe 330. In some embodiments, the collection bag 306 may be secured to the drain pipe 330 by being pinched between the drain pipe 330 and aperture 314. The collection bag 306 is passed through the aperture 314 before the drain pipe 330 is inserted such that the collection bag 306 is suspended in between the four legs 310 of the filter stand 302 beneath the platform area 312 (see FIG. 11). The collection bag 306 may be fabricated from a mesh or other type of partially porous material and in embodiments has a 25u filter capability. In embodiments, when the cylindrical filter 304B is placed into the cylindrical filter 304A and the cylindrical filter 304A is placed into the filter holder 305, resin solution may be substantially filtered through the cylindrical filters 304A and 304B and drained through the filter holder 305 into the collection bag 306. For instance, when botanical resin solution or matter is poured into the cylindrical filter 304B when the cylindrical filters are assembled, (i.e. cylindrical filter 304B within cylindrical filter 304A and cylindrical filter 304A within filter holder 305) particles being greater than 220u will not be allowed to pass through and will collect in the 220u cylindrical filter 304B, particles being greater than 160u will not be allowed to pass through and will collect in the 160u cylindrical filter 304A, and particles less than 160u will be able to pass through the filter holder 305 and collect in the 25u collection bag 306 while particles less than 25u (substantially fluids) will pass through. In other embodiments, the cylindrical filters 304A and 304B may have mesh covered openings with the mesh having alternative micron filtering capabilities which could be between 100u to 300u.

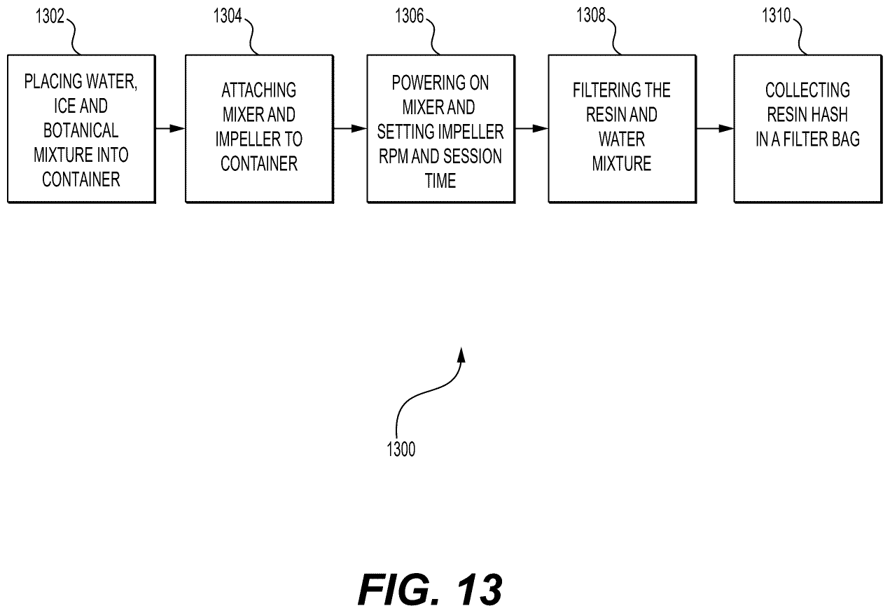

FIG. 13 shows a method 1300 for having a filter extraction system 100.

In a step 1302, a mixture of water, ice, and botanical matter is placed into the container 206. In some embodiments, the ice tray 102 (FIG. 1) is filled with water and placed in an environment capable of freezing the water, such as a freezer and then placed into container 206. In some embodiments, the container 206 is filled with 1000-mL of reverse osmosis filtered water and placed in a freezer for approximately thirty minutes to chill the water. In embodiments, it is advantageous if the water in the container 206 is at a temperature of approximately thirty-three to thirty-four degrees Fahrenheit. The botanical matter is weighed and dropped into the chilled water in the container 206. In embodiments, approximately one-hundred grams of frozen botanical resin may be dropped into the container 206 or approximately thirty grams of dry botanical resin material may be dropped into the container 206. In embodiments, the level of water/ice mixture in the container 206 may be approximately 1300 mL. It is advantageous if the botanical resin material is submerged below the surface of the water in the container 206 with the ice floating on the surface of the water. Additional ice may be added to maintain the temperature of the water approximately between thirty-three and thirty-four degrees Fahrenheit. In embodiments, it is advantageous that the buds of the plant are trimmed to approximately one and a half centimeters and the plant leaves without trichrome heads are removed. The method 1300 may be carried out using many different types of botanical matter which may vary by strain or phenotype. In some implementations, the botanical resin is allowed time to soak in the container 206 with the water and ice. In embodiments, the botanical resin material is allowed to soak for approximately 5-10 minutes if it is frozen and approximately 15-30 minutes if it is dry botanical resin material.

In some embodiments, reverse osmosis filtered water may be used to fill the ice tray 102 and throughout the method 1300 steps to avoid introducing contaminants to the resin hash.

In some implementations, the collection spray bottle 104 (FIG. 1) may be filled with water, which in embodiments may be chilled, reverse osmosis filtered water.

In a step 1304, the driver head 204 with the attached agitator assembly 202 (see FIG. 4) is placed onto the upper edge 152 of the container 206 and is secured using the container ring 208 (see FIGS. 5, 6A, and 6B). In embodiments, the agitator assembly 202 is suspended approximately one to three millimeters above the inner floor of the container 206. The container ring 208 threads are screwed onto the screw threads 150 of the container 206 and the outwardly extending ledge 230 of the driver head 204 is secured in between the inwardly extending shelf 231 of the container ring 208 and the upper edge 152 of the container 206.

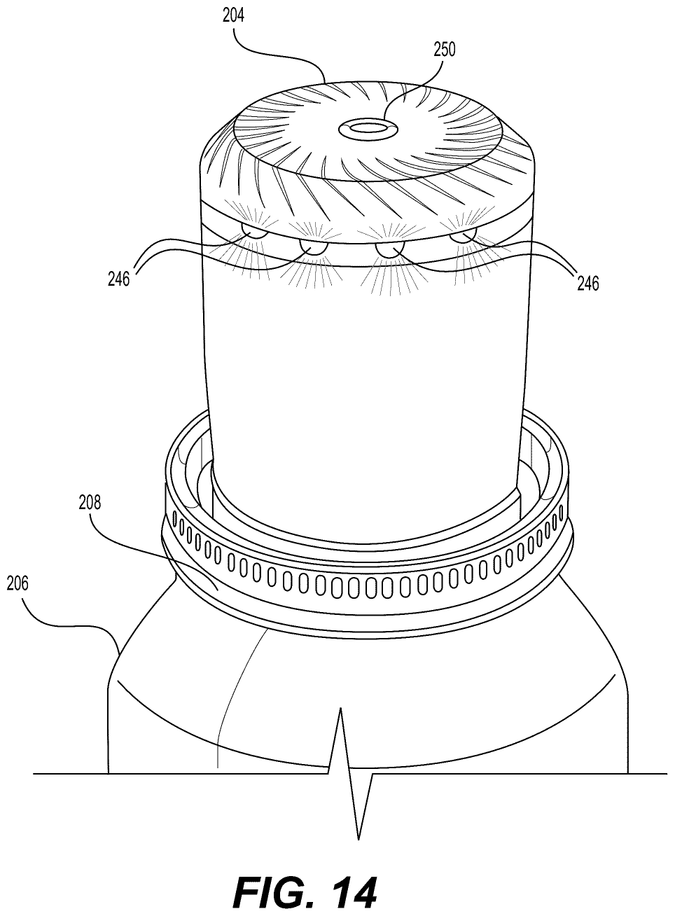

In a step 1306, the driver head 204 is powered ON and set to a desired speed (RPM) and session time to spin the agitator assembly 202. In embodiments, and with reference to FIG. 5, the driver head 204 is powered on using the power button 250 (FIG. 14) which activates the one or more Li—Po batteries 242 to provide power for the DC motor 240 configured to spin the agitator assembly 202. The mode select/power push button 250 may be used to control the RPM and session running time of the agitator assembly 202, and the LEDs 246 may indicate a session time and speed in which the agitator assembly 202 will be spun. In embodiments, the quicker the agitator assembly 202 is spun by the driver head 204 . . . . The resulting rotation of the impeller 220 and the shaft 210A/210B of the agitator assembly 202 substantially breaks up the plant matter and ice in the container 206. In embodiments, it is advantageous for all the plant matter and ice to be in continuous movement which may impact the session time and rotation speed the agitator assembly 202 is set to. The specific functionality of driver head 204 is discussed hereinafter.

In a step 1308, the resin and water mixture undergoes a filtration process. In embodiments, the driver head 204 is removed from the container 206 and the pour spout attachment 209 is secured onto the container 206 with the container ring 208 (see FIGS. 7A and 7B). In embodiments, the container ring 208 threads are screwed onto the screw threads 150 of the container 206 and the outwardly extending ledge 270 of the pour spout attachment 209 is secured in between the inwardly extending shelf 231 of the container ring 208 and the upper edge 152 of the container 206. The collection bag 306 is placed over the drain pipe 330 of the filter holder 305, fed through the aperture 314 of the filter stand 302, and the drain pipe 330 is threaded into the aperture 314 of the filter stand 302 (see FIG. 11). In embodiments, the collection bag 306 has 25u filtering capabilities which substantially allows water to pass through the bag. The threading of the drain pipe 330 of the filter holder 305 threads into the aperture 314 of the filter stand 302 and secures the filter holder 305 to the filter stand 302 while also securing the collection bag 306 over the drain pipe 330 such that botanical resin solution passing through the drain pipe 330 is directed to the collection bag 306.

In embodiments, the 220u cylindrical filter 304B is placed into the 160u cylindrical filter 304A and the cylindrical filter 304A is placed into the filter holder 305 (see FIG. 9). The filter stand 302 with the attached filter holder 305 is placed in a sink or over a drain. In some embodiments, an additional container may be placed beneath the filter stand 302 with the collection bag 306 in the additional container such that the chilled water from the container 206 may be reused. Then, botanical resin matter is poured out of the container 206 through the pour spout attachment 209 and into the cylindrical filter 304B. In embodiments, the botanical resin matter when poured is directed through the oblong portion 276 of the pour spout attachment 209 and into the cylindrical filter 304B. The container 206 may be swirled such that the resin material is evenly dispersed throughout the water. The resin solution is not poured at a rate which overfills either of the cylindrical filters 304A and 304B.

In a step 1310, resin hash is collected in the collection bag 306 while water flows through the collection bag 306 and into the drain or additional container (see FIG. 11). In embodiments, the cylindrical filter 304B, which first encounters the botanical resin solution poured from the container 206, collects resin material greater than 220u and passes water and resin material less than 220u. The cylindrical filter 304A, which next encounters the resin material able to pass from the cylindrical filter 304B, collects resin material greater than 160u and passes water and resin material less than 160u to the filter holder 305. In the filter holder 305 the remaining resin matter and water are directed through the drain pipe 330 and into the collection bag 306 where water is able to pass through the bag and the resin hash collects in the collection bag 306. In some embodiments, the resin material in the cylindrical filter 304A may be dropped into another container for another wash and step 1310 is repeated.

In some implementations, additional cold water is added to the container 206 and step 1308 may be repeated until no more resin hash is collected in the collection bag 306.

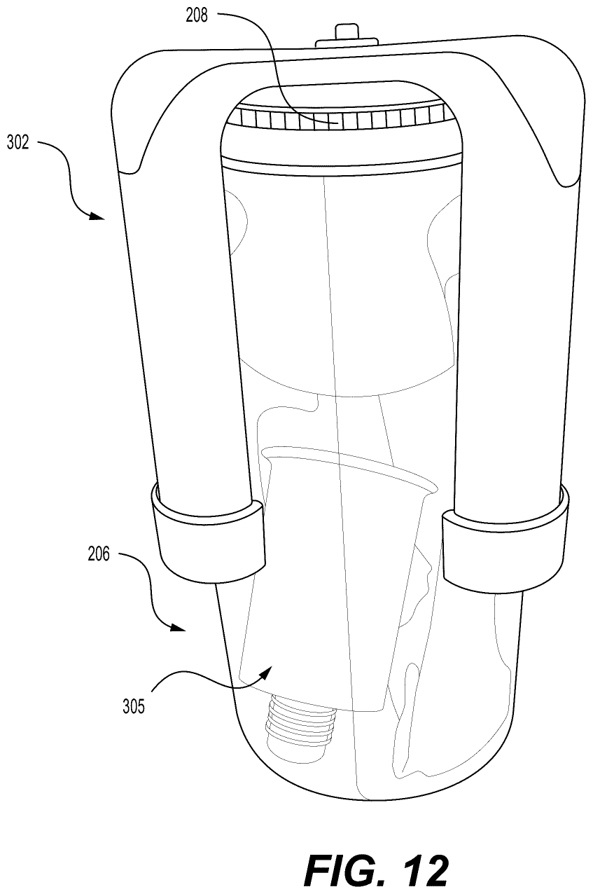

In some embodiments, the cylindrical filters 304A and 304B and the collection bag 306 are sprayed down using the collection spray bottle 104. The cylindrical filters 304A and 304B are sprayed such that additional resin hash, which may be trichrome heads, are passed into the collection bag 306. The collection bag 306 is sprayed to ensure the resin hash settles at the bottom of the collection bag 306 and any unwanted contaminates are passed out of the collection bag 306. The collection bag 306 with the resin hash is removed from the filter stand 302 and filter holder 305 for drying and the filter extraction system 100 may dissembled and stored. In embodiments, and with reference to FIG. 12, when stored, the filter stand 302 may be placed over the container ring 208 of the container 206, and the cylindrical filters 304A/304B, filter holder 305, and driver head 204 may be fit into the container 206.

When the resin hash in the collection bag 306 is dried a freeze-drying method (requiring a freeze dryer), or an air-drying method may be used. When freeze drying, the collection bag 306 is placed on a tray and inserted into the freezer where it is frozen for approximately one to two hours and dried for approximately six to eight hours. After the allotted time has passed, the hash is checked to see if it may easily be broken up, and if it is not easily broken up, additional dry time may be required. If an air-drying method is used, the collection bag 306 is dried using a cloth and placed on parchment paper such that the resin hash is evenly dispersed throughout the bag. A fan is placed near the collection bag 306 and blows air across the collection bag 306 for one to two days during which the collection bag 306 may be flipped until the resin hash is completely dry. In operation, a process operates on a processing component on PCB microcontroller 252 in response to push button commands made by a user to control aspects of the driver head 204. In general, the processing component listens for user input received from the power button on the unit. More specifically, a held button (e.g., a depression for 4 seconds or more) is used to power the unit on and off, and to initiate or shut down the motor. Single clicks shift motor speed between a plurality of modes from slow to fast. Double clicks of the power button are configured to switch the unit between a plurality of run times. Execution of maximum number of double clicks is configured to also power the unit down. A depression of the power button for a greater threshold of time is configured to reset/reboot the system.

On startup, a recognition by microcontroller 252 of an elongated depression of power button 250 (4 seconds in embodiments) by a user will result in powering the driver system on. In terms of duration, a threshold is established by the microcontroller 252 that creates a power up when the power-button threshold is exceeded. In embodiments, a recognition of a second depression of over four seconds of the power button 250 after the power up has occurred will result in activation of the motor. A user is able to change the status of the motor and the power to the driver head 204 between on and off. states at any time by making these threshold-exceeding depressions of the power button. An initial depression exceeding 4 seconds turns the motor off, whereas a second additional 4 second hold turns the power to the driver head off.

The PCB microcontroller 252 is configured to recognize a difference between an elongated depression, two simultaneous presses (a double press) and single presses as is known in other user interfaces.

Assuming there has been a power on, making single clicks, the user is able to command an operating driver head 204 to spin the agitator assembly 202 at different speeds, and then double clicks set operating time durations for the motor at the particular speed selected until the timed expiration then automatically disable the motor. Speed selection is made in response to user commands (e.g., single clicks) in steps. Run-time selections (the amount of time the driver head will run before it automatically stops) are made by the microcontroller 252 in response to distinctive user commands (double clicks). The receipt of click commands by the microcontroller 252 from the power button 250 will only occur if the unit has already been powered up with a threshold power button depression as described above.

Once on, the processing component of microcontroller 252 listens for the receipt of a single click from the power button. If no single clicks have yet been heard by the microcontroller, the process remains in a continual loop until a single click is heard. Upon receiving a single click, the process will operate the agitator assembly 202 at a low RPM speed and the LED indicator 246 will be illuminated in a manner indicating a low intensity setting.

The driver head 204 will remain at a low-speed setting unless a second single click is received by the microcontroller. If a second single click is received, the process causes the motor to operate the agitator assembly 202 at relatively higher speed (in terms of RPMs) and the LEDs 246 are illuminated in a manner indicating a relatively higher speed. The relatively low and relatively high LED indications 246 will allow the user to see visually what speed setting the driver head 204 is in.

If a third single click depression of the power button is recognized by the microcontroller, the process on the microcontroller can listens for further instructions (in the form of clicks). A third click can either loop the process back to a low power setting, or in other embodiments, go to additional power settings.

A user is also able to, by making double clicks, set a run time for the driver head 204 after which the driver head will automatically stop. If no double click is recognized by the controller 252, the process will continually loop (with motor 240 remaining powered on at the same speed). The microcontroller 252, if it recognizes a double click from a user operating the power button 250, moves to toggle the unit to a particular time-period of operation (e.g., 10 minutes in embodiments). The processor also, in parallel, uses the LED indicator 246 to indicate the duration setting (e.g., using a particular color such as blue) so that the user will know of the current duration setting.

Given an already-existing duration setting, the microcontroller 252 listens for the receipt of a second double-click of the power button 250. Receipt of a new double click sets the run time is set to an intermediate duration (e.g., 20 minutes) and the LED indicator 246 is illuminated in a different way (e.g., colored green) so that a user will know the run-time mode.

If a third double click is recognized by the microcontroller 252, the process moves on to both set the run time to a high/maximum run time setting (e.g., 30 minutes) and the LEDs 246 are illuminated red to indicate the mode.

If a fourth additional double click is recognized by the microcontroller the system is powered down.

It is contemplated that numerous other processes could be executed to accomplish the same objectives. Additionally, a variety of different LED 246 or other lighted or nonlighted displays or indicators could be used without departing from the scope herein. In some embodiments, dimmer and brighter LED 246 displays may indicate different run times. Further, different LED 246 color configurations could be used to indicate speed settings. In some embodiments, custom session times may be for run times more or less than the three-setting embodiment described above, and the times could also be different than the ten, twenty, or thirty minutes discussed above.

The LEDs 246 may also be configured to provide indication to the time remaining in a session time wherein the number of illuminated of LEDs 246 illuminated corresponds to the amount of time remaining in a session. In some embodiments, different indicators may be provided using a display screen or audible sound. The length of the run times and the rotation speed of the speed settings may be greater than or less than the time and speeds provided herein and should not be considered limiting in the scope of this application. Additionally, the processing component could be configured to use LED indications (e.g., by flashing, color, intensity) to communicate error codes to a user.

Many different arrangements of the various components depicted, as well as components not shown, are possible without departing from the spirit and scope of what is claimed herein. Embodiments have been described with the intent to be illustrative rather than restrictive. Alternative embodiments will become apparent to those skilled in the art that do not depart from what is disclosed. A skilled artisan may develop alternative means of implementing the aforementioned improvements without departing from what is claimed.

It will be understood that certain features and subcombinations are of utility and may be employed without reference to other features and subcombinations and are contemplated within the scope of the claims. Not all steps listed in the various figures need be carried out in the specific order described.

What is claimed is:

1. A system comprising:
a container;
a driver head;
a shaft configured to be suspended down into the container and operatively connected to the driver head to rotate the shaft;
a first downwardly directed impeller located at an intermediate portion of the shaft to create downwardly directed turbulence; and
a second upwardly directed impeller located at a lower position on the shaft to create an upwardly directed turbulence opposite the downwardly directed turbulence generated by the first downwardly directed impeller.

2. The system of claim 1, wherein the shaft comprises a driver-attaching end configured to be pushed into and held within a hub fitting of the driver head such that the driver-attaching end may be removed from and secured into the driver head.

3. The system of claim 1, wherein the driver head comprises an outwardly extending ledge configured to sit on an upper edge of the container directly above screw threads disposed around a mouth of the container, the screw threads being configured for receiving a container ring.

4. The system of claim 3, wherein the container ring comprises an inwardly extending shelf, and the outwardly extending ledge of the driver head is clamped above the upper edge of the container and underneath the inwardly extending shelf when the container ring is screwed onto the screw threads.

5. The system of claim 1, wherein the driver head comprises:
a controller configured to receive inputs and control an operating speed and a session time of the driver head; and
an indicator arrangement comprising a plurality of light emitting diodes (LEDs) radially spaced apart on an upper portion of the driver head, the plurality of LEDs being responsive to an operational status.

6. The system of claim 5, wherein the controller is communicatively coupled to the indicator arrangement such that the controller controls an illumination intensity and color of the LEDs to correspond to the operating speed and the session time of the shaft.

7. The system of claim 1, wherein the first downwardly directed impeller comprises flow-compelling ridges extending downwards from a lower facing surface of the first downwardly directed impeller, and the flow-compelling ridges compel flow downwards towards the second upwardly directed impeller.

8. The system of claim 1, wherein the second upwardly directed impeller comprises flow-compelling ridges extending upwards from an upper facing surface of the second upwardly directed impeller, and the flow-compelling ridges compel flow upwards towards the first downwardly directed impeller.

9. A system comprising:
a container comprising a wide-mouth and screw threads disposed around the circumference of the wide-mouth wherein the screw threads are configured for receiving a container ring;
a driver head configured to be clamped between the container and the container ring directly above the wide-mouth of the container, wherein the driver head is configured to operatively connect to a shaft suspended in between walls of the container;
wherein the shaft comprises an impeller configured to generate flow dynamics.

10. The system of claim 9, wherein the driver head comprises an outwardly extending ledge which extends around the circumference of the driver head such that the circumference of the outwardly extending ledge matches the circumference of an upper edge of the wide-mouth of the container and the outwardly extending ledge sits directly on the upper edge.

11. The system of claim 10, wherein the container ring comprises an inwardly extending shelf, and the outwardly extending ledge of the driver head is clamped between the upper edge of the container and the inwardly extending shelf when the container ring is screwed onto the screw threads.

12. The system of claim 10, comprising a pour spout attachment as an alternative attachment to the driver head, the pour spout attachment having an outwardly extending ledge having a diameter which is substantially identical to that of the outwardly extending ledge of the driver head such that the pour spout attachment may be clamped between the upper edge of the container and the inwardly extending shelf when the container ring is screwed onto the screw threads.

13. The system of claim 9, comprising a filter accessory kit, the kit including:
a filter holder comprising a substantially cylindrical wall, a floor, and a drain pipe extending down from the floor;
a filter stand wherein the filter stand includes a platform area having an aperture defined therethrough, the aperture being sized to receive the drain pipe therethrough when the filter holder is placed atop the platform area, the platform area supported atop a plurality of legs, each leg in the plurality initially radiating out from the platform area, then extending downwardly to support the platform above a surface;
the drain pipe configured to receive a collection bag.

14. The system of claim 13, comprising a first cylindrical filter and a second cylindrical filter wherein the second cylindrical filter has a smaller diameter than the first cylindrical filter and fits within the first cylindrical filter, and the first cylindrical filter is configured to be received inside the substantially cylindrical wall of the filter holder.

15. The system of claim 14, wherein the first cylindrical filter comprises a first mesh lining which stretches across the bottom of the first cylindrical filter and the second cylindrical filter comprises a second mesh lining, which stretches across the bottom of the second cylindrical filter.

16. The system of claim 15, wherein the first mesh lining has a mesh structure more tightly woven than a mesh structure of the second mesh lining, such that the first cylindrical filter collects matter which passes through the second cylindrical filter.

17. The system of claim 13, wherein the legs of the filter stand are configured to be at a distance apart such that they can accomplish a secured fit around the container when the driver head and the pour spout attachment are removed from the container.

18. The system of claim 13, wherein a set of external threads on the drain pipe are configured to mate with a set of corresponding internal threads existing in the aperture in the platform, enabling the drain pipe to be screwed through and partially extend below the platform exposing a drain tip that can then receive a collection bag.

19. The system of claim 18, further comprising:
a pour spout attachment configured to be attached to the container alternatively to the driver head; and
the filter holder is configured to be attachable to the filter stand such that when a solution is poured out of the container and through the first and the second cylindrical filters supported within the filter holder, the drain pipe, and then the collection bag, diverse forms of plant matter are established in each of the first and the second cylindrical filters and the collection bag.

20. A system comprising:
a container comprising a wide-mouth and screw threads disposed around the circumference of the wide-mouth wherein the screw threads are configured for receiving a container ring;
a driver head configured to be clamped between the container and the container ring directly above the wide-mouth of the container;
a shaft configured to be suspended down into the container and operatively connected to the driver head to rotate the shaft;
a first downwardly directed impeller located at an intermediate portion of the shaft to create downwardly directed turbulence;
a second upwardly directed impeller located at a lower position on the shaft to create an upwardly directed turbulence opposite the downwardly directed turbulence generated by the downwardly directed impeller;
a filter holder comprising an outer shell and a hollow shaft extending from a bottom surface of the outer shell, wherein the hollow shaft comprises external threads around its circumference; and
a filter stand wherein the filter stand includes legs spaced apart and which converge together towards a threaded hole establishing a platform for supporting the driver head, wherein the threaded hole is configured to receive the external threads of the hollow shaft to attach the filter holder to the filter stand.
